(19) United States
(12) Patent Application Publication
(10) Pub. No.: US 2026/0249440 A1
(43) Pub. Date: Aug. 27, 2026

(54) ELECTRIC TOOL

(71) Applicant: MetaSee LLC, AUSTIN, TX (US)

(72) Inventor: Jianhai Zheng, Shenzhen (CN)

(21) Appl. No.: 19/455,740

(22) Filed: Jan. 21, 2026

(30) Foreign Application Priority Data
Feb. 25, 2025 (CN) 202520318007.1

(51) Int. Cl. B25F 5/00

(52) U.S. Cl. CPC B25F 5/001

(57) ABSTRACT

An electric tool includes: a housing; a mounting member connectable with a tool bit; an actuating mechanism arranged within the housing and connected to the mounting member; an adjustment mechanism including an adjustment assembly and a detection assembly; and a control module electrically connected to the actuating mechanism and the detection assembly. The adjustment assembly includes a moving member, a connecting member, and a pushing member. The moving member, the connecting member, the pushing member, and the detection assembly are all arranged within the housing. The moving member and the pushing member are movable relative to the mounting member. The moving member abuts against the connecting member. The pushing member is connected to the moving member. The pushing member is to drive the moving member to move, and the detection assembly is to generate a corresponding output based on a relative position or relative displacement of the moving member.

### CROSS REFERENCE TO RELATED APPLICATIONS

This application claims priority to Chinese Patent Application No. CN 202520318007.1, filed February 25, 2025, which is hereby incorporated by reference herein as if set forth in its entirety.

### TECHNICAL FIELD

The present disclosure generally relates to electric tools, and in particular relates to an electric tool capable of precise output adjustment.

### BACKGROUND

Electric power tools are indispensable assistants in industrial production and daily household life, as they can easily accomplish tasks that are difficult or time-consuming to complete using manual tools, thereby improving working efficiency. Different working attachments can be mounted according to different working environments. An actuating mechanism drives a mounting assembly to rotate, thereby driving the working attachment to rotate so as to achieve different functions.

Generally, in order to adjust the torque of some conventional electric power tools, the electric power tools typically include a rotating sleeve that can be manually rotated to adjust the output torque. However, during an initial stage of rotating the rotating sleeve, excessive rotational displacement is likely to occur, resulting in inaccurate torque adjustment in the initial stage.

### BRIEF DESCRIPTION OF DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric view of an electric tool according to one embodiment.

FIG. 2 is an isometric sectional view of the electric tool.

FIG. 3 is an isometric sectional view of the housing of the electric tool according to one embodiment.

FIG. 4 is an isometric exploded view of the actuating mechanism of the electric tool according to one embodiment.

FIG. 5 is an isometric exploded view of the adjustment mechanism of the electric tool according to one embodiment.

FIG. 6 is another isometric exploded view of the adjustment mechanism of the electric tool according to one embodiment.

FIG. 7 is an isometric exploded view of the adjustment mechanism showing only the moving member and connecting member.

FIG. 8 is an enlarged view of a portion A in FIG. 5.

FIG. 9 is an isometric view of the pushing member of the electric tool according to one embodiment.

FIG. 10 is an isometric view of an electric tool, with some elements omitted for clarity.

FIG. 11 is an isometric exploded view of the detection assembly according to one embodiment.

FIG. 12 is a schematic block diagram of the electric tool according to one embodiment.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

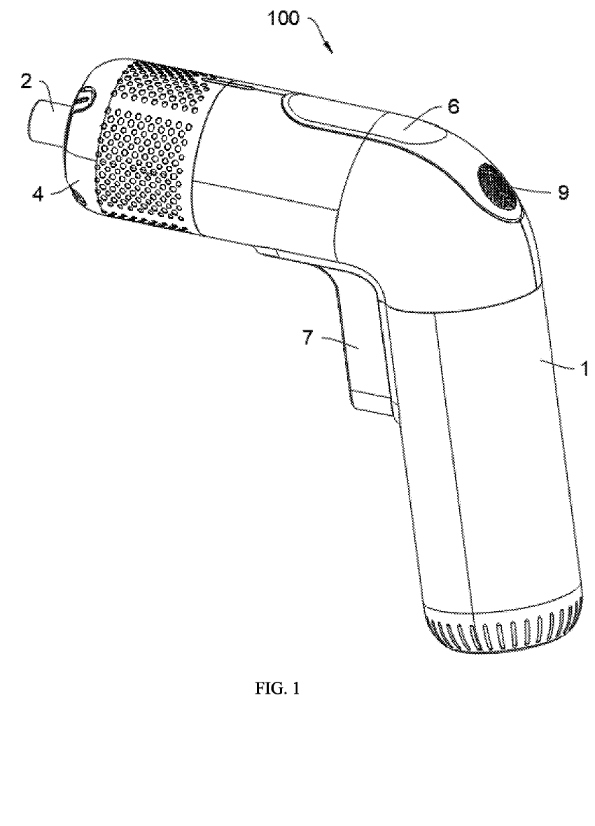

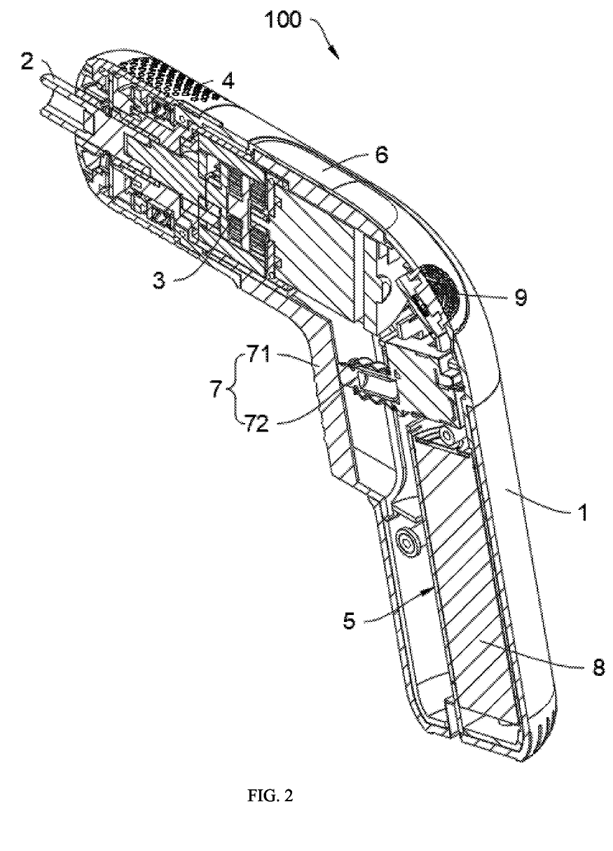

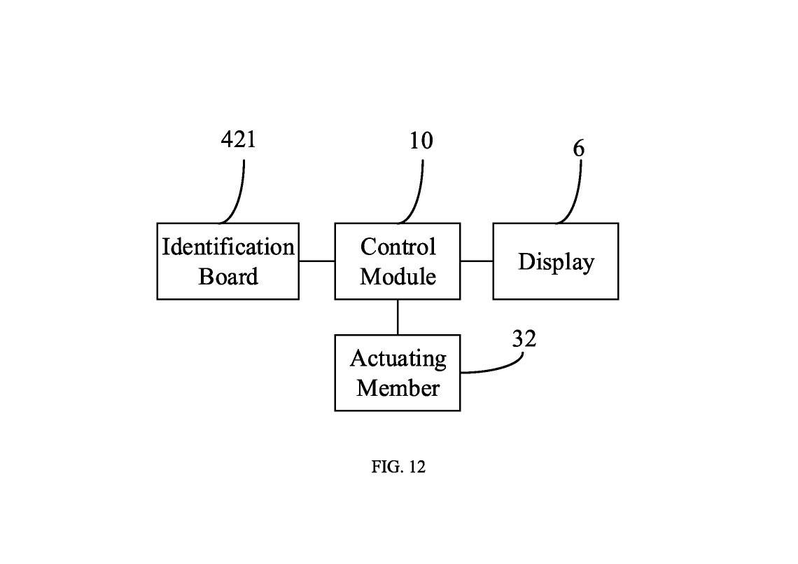

Referring to FIGS. 1 and 2, the present disclosure provides an electric tool 100. In one embodiment, the electric tool 100 includes a housing 1, a mounting member 2, an actuating mechanism 3, an adjustment mechanism 4, and a control circuit board 5. A control module 10 (e.g., a controller, see FIG. 12) is provided on the control board 5. The mounting member 2 is configured for insertion and mounting of a tool bit, and the tool bit may be a screwdriver bit, a drill bit, a grinding head, a cleaning head, or the like. The actuating mechanism 3 is arranged in the housing 1 and is connected to the mounting member 2. The actuating mechanism 3 is to drive the mounting assembly 2 to move, thereby driving the tool bit to move. The adjustment mechanism 4 is arranged in the housing 1. The control board 5 is electrically connected to the actuating mechanism 3 and the adjustment mechanism 4, and the control board 5 is to control the actuating mechanism 3, for example, by adjusting an output torque, an output power, and an output rotational speed of the actuating mechanism 3.

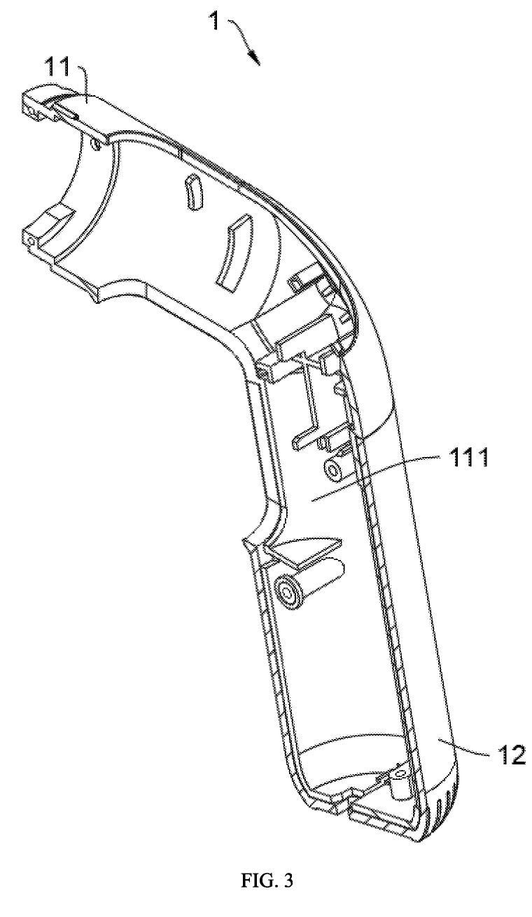

With regard to the housing 1 described above, referring to FIG. 3, the housing 1 may include an outer housing 11 and a sleeve 12. The outer housing 11 is provided with a receiving chamber 111 that accommodates the control board 5. The sleeve 12 is detachably arranged around one end of the outer housing 11. The sleeve 12 and the outer housing 11 may be connected to each other by bonding, threaded connection, snap-fit connection, or the like. The present disclosure is not limited in this regard, as long as a detachable connection between the sleeve 12 and the outer housing 11 is realized.

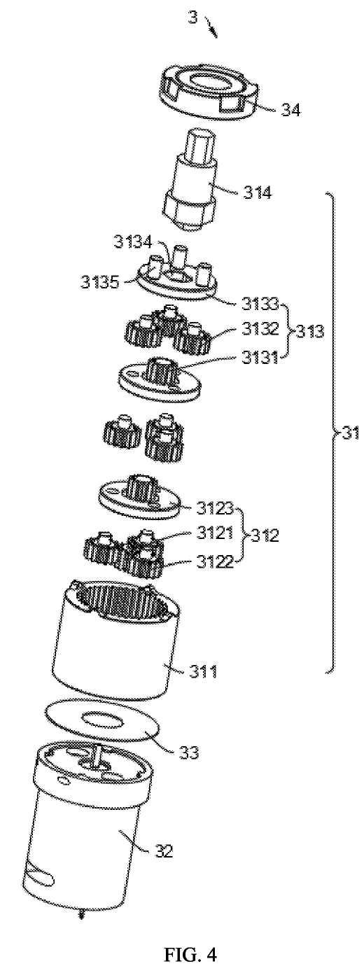

In another embodiment, the outer housing 11 and the sleeve 12 may be formed as an integral, non-detachable structure, as long as a receiving chamber 111 is formed in the housing 1. With regard to the actuating mechanism 3 described above, referring to FIG. 4, the actuating mechanism 3 may include a transmission assembly 31, an actuating member 32, a first washer 33, and a press sleeve 34. One end of the transmission assembly 31 is arranged in the receiving chamber 111, and the other end of the transmission assembly 31 is connected to the mounting member 2. The actuating member 32 is arranged in the receiving chamber 111 and is connected to the transmission assembly 31. The actuating member 32 is electrically connected to the control board 5 and is to drive the transmission assembly 31 to rotate. The first washer 33 is arranged in the receiving chamber 111 and is located between the actuating member 32 and an end portion of the transmission assembly 31. The press sleeve 34 is arranged around an end of the transmission assembly 31 away from the actuating member 32, and the press sleeve 34 is to limit the transmission assembly 31. In one embodiment, the actuating member 32 is a motor.

The transmission assembly 31 includes a transmission sleeve 311, at least one input transmission structure 312, an output transmission structure 313, and an output shaft 314. The transmission sleeve 311 is arranged in the receiving chamber 111 and abuts the adjustment mechanism 4. The transmission sleeve 311 is rotatable relative to the receiving chamber 111. The first washer 33 is located between the transmission sleeve 311 and the actuating member 32. The input transmission structure 312 is disposed in the transmission sleeve 311 and is connected to the transmission sleeve 311, one end of the input transmission structure 312 being connected to the actuating member 32. The output transmission structure 313 is arranged within the transmission sleeve 311 and is connected to the transmission sleeve 311, one end of the output transmission structure 313 being connected to the other end of the input transmission structure 312. The press sleeve 34 is to abut the output transmission structure 313, thereby limiting the output transmission structure 313. One end of the output shaft 314 is connected to the other end of the output transmission structure 313, and one end of the output shaft 314 extends through the press sleeve 34. The other end of the output shaft 314 is connected to the mounting member 2.

In one embodiment, the inner lateral surface of the transmission sleeve 311 is provided with an internal gear. The input transmission structure 312 includes an input sun gear 3121, a number of input planetary gears 3122, and an input planetary carrier 3123. The input sun gear 3121 is connected to the actuating member 32. The input planetary gears 3122 mesh with the input sun gear 3121 and the transmission sleeve 311, respectively. The input planetary carrier 3123 is connected to the input planetary gears 3122 and the output transmission structure 313.

In one embodiment, the number of input transmission structures 312 is two. The two input transmission structures 312 are adjacent to and connected with each other. One of the input transmission structures 312 is connected to the actuating member 32, and the other of the input transmission structures 312 is connected to the output transmission structure 313.

In one embodiment, the output transmission structure 313 includes an output sun gear 3131, a number of output planetary gears 3132, and an output planetary carrier 3133. The output sun gear 3131 is connected to the input planetary carrier 3123. The output planetary gears 3132 mesh with the output sun gear 3131 and the transmission sleeve 311, respectively. The output planetary carrier 3133 is connected to the output planetary gears 3132 and is provided with a through hole 3134. The through hole 3134 is a non-circular hole, and one end of the output shaft 314 is inserted into the through hole 3134. The non-circular through hole 3134 ensures that the output shaft 314 does not rotate relative to the output planetary carrier 3133. The output planetary carrier 3133 is to abut the press sleeve 34, such that the press sleeve 34 can limit the output planetary carrier 3133.

In one embodiment, to further limit the output shaft 314 and prevent it from rotating relative to the output planetary carrier 3133, the output planetary carrier 3133 is provided with a number of limiting posts 3135. The limiting posts 3135 surround one end of the output shaft 314 and abut against that end of the output shaft 314.

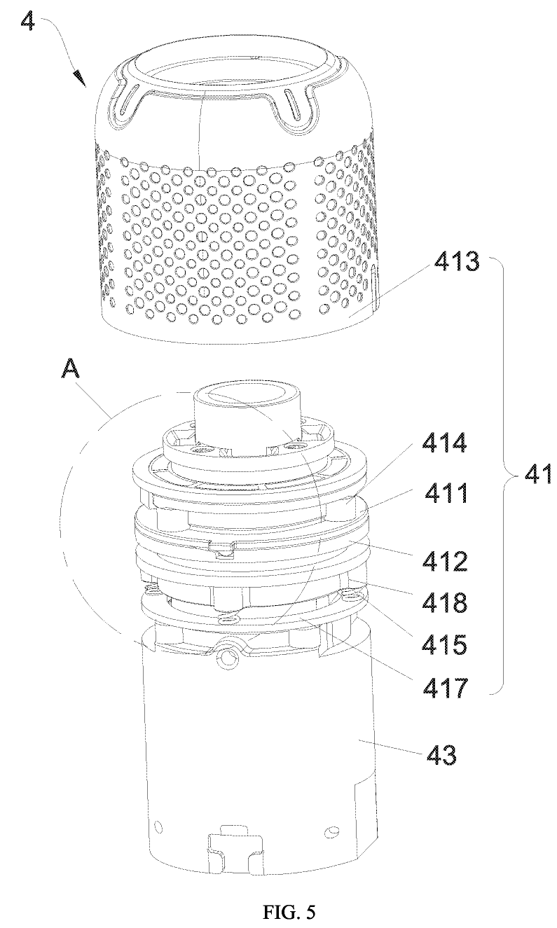

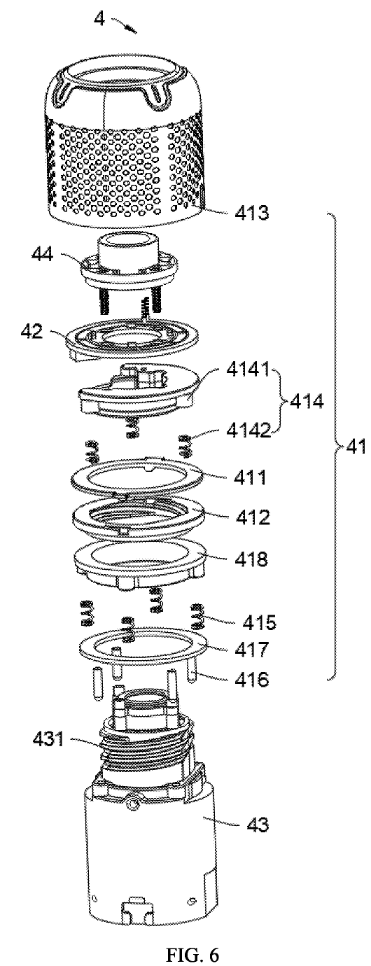

Referring to FIGS. 5 and 6, the adjustment mechanism 4 includes an adjustment assembly 41 and a detection assembly 42. Both the adjustment assembly 41 and the detection assembly 42 are disposed in the outer housing 11. The adjustment assembly 41 abuts the transmission sleeve 311 and is movable relative to the outer housing 11 and the mounting assembly 2. The detection assembly 42 is connected to the adjustment assembly 41 and electrically connected to the control board 5.

Referring to FIGS. 5 and 6, the adjustment assembly 41 includes a moving member 411, a connecting member 412, and a pushing member 413. The moving member 411, the connecting member 412, and the pushing member 413 are all arranged in the outer housing 11. Specifically, the pushing member 413 is movably connected to the outer housing 11—for example, it is movably arranged around a front end of the outer housing 11 to facilitate user operation. In one embodiment, the pushing member 413 is rotatably connected to the outer housing 11. In another embodiment, the pushing member 413 may be slidably connected to the outer housing 11. The moving member 411 is movably arranged within the outer housing 11 and is connected to the pushing member 413 so as to move together with the pushing member 413. The connecting member 412 is arranged within the outer housing 11. The moving member 411 and the pushing member 413 are movable relative to the mounting member 2 and the outer housing 11. The moving member 411 abuts the connecting member 412, and the pushing member 413 is connected to the moving member 411 and is to drive the moving member 411 to move. The detection assembly 42 is to generate a corresponding output in response to movement of the pushing member 413 relative to the housing 1. For example, the detection assembly 42 can generate an output according to a relative position or displacement of the moving member 411, and the control board 5 controls the actuating member 32 according to this output—for instance, to control the output torque of the actuating member 32, thereby adjusting the output torque of the actuating mechanism 3. The moving member 411 abut against the connecting member 412, thereby providing a certain damping effect. As a result, when the user initially pushes the pushing member 413 to drive the moving member 411, the movement speed of the moving member 411 can be slowed, preventing excessive displacement and ensuring accurate torque adjustment during the initial stage.

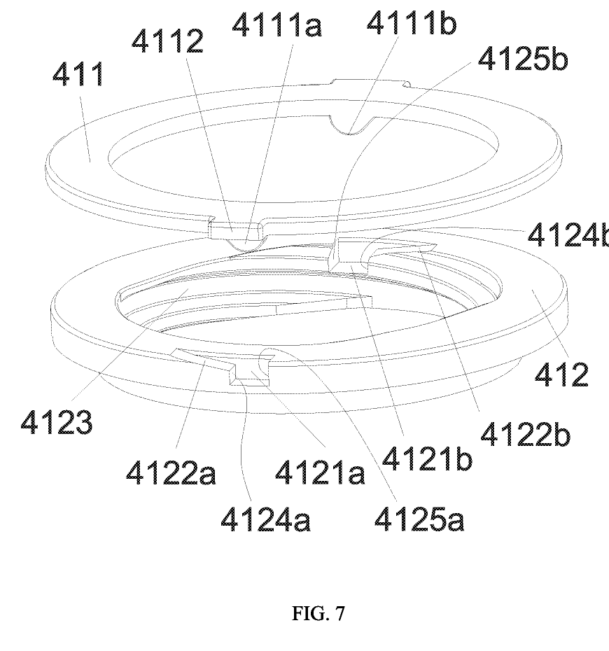

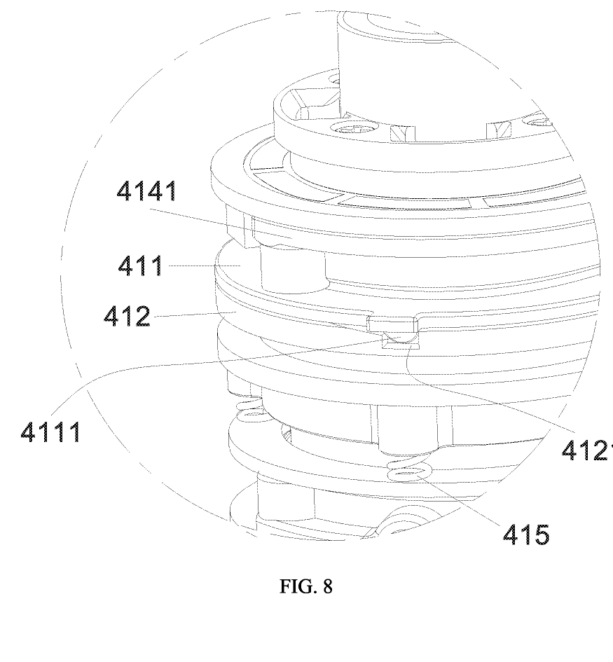

In one embodiment, referring to FIGS. 7 and 8, a resistance mechanism is provided between the connecting member 412 and the moving member 411. The resistance mechanism is to provide damping for relative movement of the moving member 411 with respect to the connecting member 412. It should be noted that the resistance mechanism is not limited to being disposed between the connecting member 412 and the moving member 411. In other embodiments, the resistance mechanism may be disposed between the pushing member 413 and the detection assembly 42, or between the pushing member 413 and the housing 1.

In one embodiment, the resistance mechanism is to provide damping when the moving member 411 starts to rotate from a specific position relative to the connecting member 412, rather than continuously providing damping throughout the entire movement of the moving member 411 relative to the connecting member 412. Specifically, a protrusion 4111 is provided on one side of the moving member 411. The connecting member 412 is provided with a groove 4121 and a guide inclined surface 4122. The groove 4121 is to receive the protrusion 4111. One end of the guide inclined surface 4122 is connected to a first side surface of the groove 4121, and the other end of the guide inclined surface 4122 is connected to a surface of the connecting member 412 facing the moving member 411. That is, the guide inclined surface 4122 extends from a first side surface of the groove 4121 to a surface of the connecting member 412 facing the moving member 411. Both the guide inclined surface 4122 and the surface of the connecting member 412 facing the moving member 411 are configured to abut the protrusion 4111. When the user pushes the pushing member 413 in a first direction, thereby driving the moving member 411 to move in the first direction, the guide inclined surface 4122 guides the protrusion 4111 to move out of the groove 4121. During movement of the protrusion 4111 along the guide inclined surface 4122, the movement speed of the moving member 411 is reduced, thereby providing the damping effect.

In one embodiment, two protrusions 4111, two grooves 4121, and two guide inclined surfaces 4122 are provided. Each groove 4121 receives one protrusion 4111, one end of each guide inclined surface 4122 is connected to a first side surface of a corresponding groove 4121, and the other end of each guide inclined surface 4122 is connected to the surface of the connecting member 412 facing the moving member 411.

In the foregoing embodiments, the resistance mechanism is to provide damping when the pushing member 413 starts to move from its initial position relative to the housing 1. In one embodiment, the initial position of the pushing member 413 corresponds to a position at which the output torque of the power tool 100 is zero. In this way, when a user attempts to increase the output torque of the electric tool 100 by rotating the pushing member 413, the damping provided by the resistance mechanism causes the rotation of the pushing member 413 to be slow and smooth, thereby preventing the user from inadvertently adjusting the output torque of the electric tool 100 directly from zero to an excessively large value. In another embodiment, the resistance mechanism is to provide damping throughout the entire movement of the pushing member 413. This allows the pushing member 413 to move slowly over its entire range of motion, which is beneficial for enabling the user to adjust the output torque of the power tool 100 in a stable and precise manner.

It should be understood that the resistance mechanism is not limited to the foregoing structures. In other embodiments, the resistance mechanism may be formed by magnetic components that attract or repel each other. Alternatively, the resistance mechanism may be provided between two surfaces that are in mutual contact and movable relative to each other, with a relatively high friction force being present between the two surfaces.

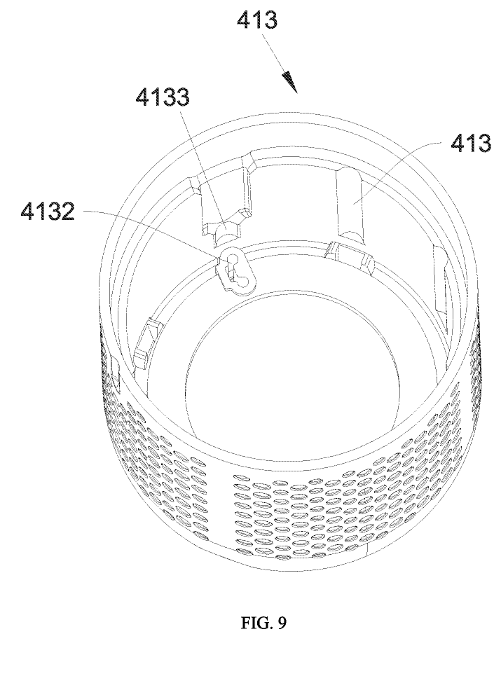

In one embodiment, referring to FIGS. 7 and 9, a second receiving groove 4133 is formed on a circumferential inner surface of the pushing member 413, and the moving member 411 is provided with a connecting portion 4112. The connecting portion 4112 is inserted into the second receiving groove 4133, such that the pushing member 413 is connected to the moving member 411. In this way, the moving member 411 is able to rotate together with the pushing member 413.

In one embodiment, two connecting portions 4112 and two second receiving grooves 4133 are provided, and the two connecting portions 4112 are respectively inserted into the two second receiving grooves 4133. Further, in another embodiment, in order to facilitate assembly, the number of the second receiving grooves 4133 is greater than two.

In one embodiment, referring to FIGS. 5 and 6, in order to further reduce the moving speed of the moving member 411, the adjustment assembly 41 includes a support assembly 414. The support assembly 414 includes a support ring 4141 and one or more first elastic members 4142. The following description takes an example in which the number of the first elastic members is three. The support ring 4141 is arranged in the housing 11 and supports the detection assembly 42. The first elastic members 4142 are abutted between the support ring 4141 and the moving member 411. The moving member 411 is subjected to a pushing force from the first elastic members 4142. When the protrusions 4111 are received in the grooves 4121, the pushing force maintains the protrusion 4111 within the groove 4121. Accordingly, when a user attempts to rotate the pushing member 413, the user must overcome the resistance jointly generated by the first elastic members 4142 and the engagement between the protrusions 4111 and the grooves 4121, thereby making the movement of the pushing member 413 smoother, more controlled, and less abrupt. In one embodiment, the first elastic members 4142 are coil springs.

In one embodiment, referring to FIGS. 5 and 6, the adjustment mechanism 4 includes a fixing member 43. One end of the fixing member 43 is located in the receiving chamber 111, and is arranged around the transmission sleeve 311 and the pressure sleeve 34, with the fixing member 43 abutting against the pressure sleeve 34. The other end of the fixing member 43 is arranged around the mounting member 2 and a transmission shaft. The support ring 4141, the moving member 411, the connecting member 412, and the pushing member 413 are all arranged around the fixing member 43. The pushing member 413 is detachably arranged around the housing 11, such that the pushing member 413 is capable of driving the moving member 411 to rotate in a first direction and in a second direction, the first direction being opposite to the second direction.

In one embodiment, two protrusions 4111 are circumferentially arranged on the moving member 411. A distance from one side of one protrusion 4111 (also referred to as protrusion 4111b, as shown in FIG. 7) to a central axis of the moving member 411 is smaller than a distance from one side of the other protrusion 4111 (also referred to as protrusion 4111a, as shown in FIG. 7) to the central axis of the moving member 411. Correspondingly, a distance from one side of one groove 4121 (also referred to as groove 4121b, as shown in FIG. 7) to a central axis of the connecting member 412 is smaller than a distance from one side of the other groove 4121 (also referred to as groove 4121a, as shown in FIG. 7) to the central axis of the connecting member 412, such that each groove 4121 is configured to receive a corresponding protrusion 4111, thereby allowing the moving member 411 to rotate through 360 degrees relative to the connecting member 412. With respect to the groove 4121a, the corresponding guide inclined surface 4122a extends from a first side surface 4124a of the groove 4121a to a surface of the connecting member 412 facing the moving member 411, and a second side surface 4125a of the groove 4121a is opposite to the first side wall 4124a. Similarly, with respect to the groove 4121b, the corresponding guide inclined surface 4122b extends from a first side surface 4124b of the groove 4121b to the surface of the connecting member 412 facing the moving member 411, and a second side surface 4125b of the groove 4121b is opposite to the first side surface 4124b.

In one embodiment, referring to FIGS. 5 and 6, the adjustment assembly 41 includes one or more second elastic members 415 and a first abutting member 416. The following description takes an example in which the number of the second elastic members 415 is four. One end of each second elastic member 415 abuts against the first abutting member 416, and the other end of the second elastic member 415 abuts against the connecting member 412. The first abutting member 416 is disposed on the fixing member 43 and is movable relative to the fixing member 43. The first abutting member 416 abuts against the transmission sleeve 311. The first abutting member 416 is urged by the second elastic members 415 to tightly press against one end of the transmission sleeve 311, such that when a load torque borne by the actuating member 32 does not exceed a preset value, the transmission sleeve 311 remains stationary. Specifically, one end of the transmission sleeve 311 that faces away from the driving member 32 protrudes with one or more arc-shaped protrusions 3111 (see FIG. 4). The following description takes an example in which the number of the protrusions 3111 is four. The four protrusions 3111 are evenly distributed along a circumferential direction of the transmission sleeve 311. Correspondingly, the number of the first abutting members 416 is also four. End portions of the four first abutting members 416 are respectively and tightly pressed against side surfaces of the four protrusions 3111. With such a configuration, when the load torque borne by the actuating member 32 does not exceed the preset value, the transmission sleeve 311 is able to remain stationary. Accordingly, the output planetary gears 3132 meshing with the internal gear of the transmission sleeve 311 rotate around the output sun gear 3131 under driving of the output sun gear 3131, thereby driving the output planetary carrier 3133 to rotate. Rotation of the output planetary carrier 3133 ultimately drives the output shaft 314 to rotate.

When the load torque borne by the actuating member 32 exceeds the preset value, the output shaft 314 together with the mounting member 2 is unable to continue rotating. At this time, the torque output by the actuating member 32 is sufficient to cause the transmission sleeve 311 to overcome the resistance provided by the first abutting members 416 and rotate. Accordingly, end portions of the first abutting members 416 slide relative to end portions of the transmission sleeve 311. In this state, a motor shaft of the actuating member 32 continues to rotate, while the output torque of the actuating member 32 is limited to a safe upper threshold. As a result, abnormal increases in current of the actuating member 32 caused by overload are avoided, thereby preventing overcurrent, overheating, insulation aging, or even burnout of the actuating member 32.

In one embodiment, referring to FIGS. 5 and 6, in order to apply force to the transmission sleeve 311 more effectively, the adjustment assembly 41 further includes a second washer 417. The second washer 417 is arranged around the fixing member 43 and is positioned between the second elastic members 415 and the first abutting member 416. The second washer 417 abuts against the second elastic members 415 and the first abutting member 416. In one embodiment, the second elastic members 415 are coil springs.

In one embodiment, referring to FIGS. 7 and 9, in order to adjust an output torque of the transmission assembly 31, an inner lateral surface of the connecting member 412 is provided with an internal thread 4123, and the fixing member 43 is provided with an external thread 431. The external thread 431 is threadedly engaged with the internal thread 4123. A second side wall of each groove 4121 is a vertical surface and is opposite to a first side surface of the groove 4121. When the protrusions 4111 are received in the grooves 4121 and the pushing member 413 is operated to drive the moving member 411 to rotate in a second direction, the connecting member 412 is driven to rotate while moving axially, which compresses the second elastic member 415, thereby applying a greater pushing force to the transmission sleeve 311. The threaded connection between the connecting member 412 and the fixing member 43 further provides resistance that impedes relative movement of the moving member 411 with respect to the connecting member 412. The second elastic members 415 are in a compressed state and apply a pushing force to the connecting member 412, thereby providing resistance to impede rotation of the connecting member 412 relative to the fixing member 43. Due to the pushing force applied by the first elastic members 4142 to the moving member 411 and the pushing force applied by the second elastic members 415 to the connecting member 412, when the pushing member 413 drives the moving member 411 to rotate in the first direction, a user is required to overcome resistance generated by the engagement between the protrusion 4111 and the guide inclined surface 4122, as well as resistance generated by the threaded connection between the connecting member 412 and the fixing member 43. The presence of the above-described resistance enables the moving member 411 to move smoothly relative to the connecting member 412, thereby allowing the resistance mechanism to provide damping when the pushing member 413 begins to move from its initial position relative to the housing 1.

In one embodiment, referring to FIGS. 5 and 6, the adjustment assembly 41 further includes a movable member 418. The movable member 418 is arranged around the fixing member 43 and is movable relative to the fixing member 43. The movable member 418 abuts against the connecting member 412 and the second elastic members 415, such that, when the connecting member 412 is rotated under driving of the moving member 411, the movable member 418 is driven to slide so as to compress the second elastic members 415.

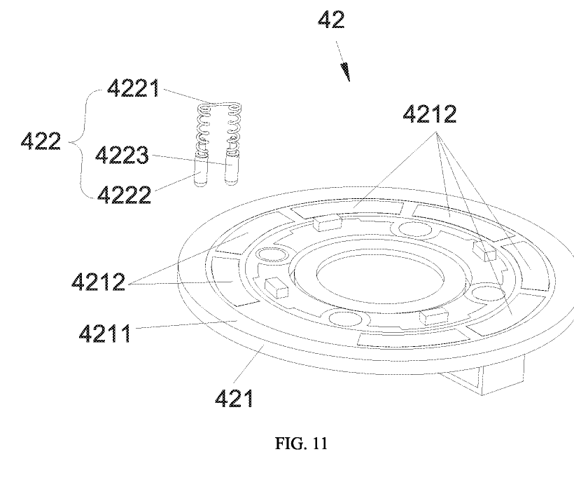

Referring to FIG. 11, the detection assembly 42 includes an identification board 421 and an adjustment member 422. The adjustment member 422 and the identification board 421 are configured such that movement of the adjustment member 422 relative to the identification board 421, driven by the pushing member 413, causes a change in an output of the identification board 421. Specifically, the identification board 421 is arranged around the mounting member 2 and is electrically connected to the control board 5. The adjustment member 422 is connected to the pushing member 413 and abuts against the identification board 421. Driven by the pushing member 413, the adjustment member 422 moves relative to the identification board 421, thereby changing a relative position between the adjustment member 422 and the identification board 421. In other words, a relative position of the moving member 411 changes accordingly. The identification board 421 is to generate a corresponding output based on the position of the adjusting member 422, which is then transmitted to the control board 5.

In one embodiment, the top surface of the identification board 421 is provided with a first identification member 4211 and a number of second identification members 4212. The second identification members 4212 are spaced apart from one another and are spaced apart from the first identification element 4211. Both ends of the adjustment member 422 abut against the identification board 421. When the adjustment member 422 moves along with the pushing member 413, one end of the adjustment member 422 remains in contact with the first identification member 4211, while the other end is capable of sequentially contacting the second identification members 4212 at different positions. As a result, the first identification member 4211 can be electrically connected to the different second identification members 4212 in sequence, so that movement of the adjustment member 422 relative to the identification board 421 causes a change in the output resistance of the identification board 421.

In one embodiment, the first identification member 4211 is annular. The second identification members 4212 are spaced apart from one another in the circumferential direction of the identification board 421. The second identification members 4212 are located within the area enclosed by the first identification member 4211, and each second identification member 4212 is radially spaced from the first identification member 4211. Each second identification member 4212 has the same shape; for example, each second identification member 4212 is arc-shaped, and the second identification members 4212 share the same center as the first identification member 4211. The adjustment member 422 is connected to the pushing member 413. One end of the adjustment member 422 abuts against the first identification member 4211, thereby establishing electrical connection between the adjustment member 422 and the first identification member 4211. The other end of the adjustment member 422 is to abut against one of the second identification members 4212, thereby electrically connecting that second identification member 4212 to the adjustment member 422. In this way, the first annular identification member 4211 and one second identification member 4212 are electrically connected to each other. By adjusting the relative position of the adjustment member 422 relative to the identification board 421, i.e., by moving the adjustment member 422 relative to the identification board 421 through the pushing member 413 to different positions, the first identification member 4211 can be electrically connected to different second identification members 4212 in sequence, thereby producing different outputs from the identification board 421. For example, in one embodiment, both the first identification member 4211 and the second identification members 4212 are resistors (e.g., thin film resistors), where each second identification member 4212 may be a fixed-value resistor or a variable-value resistor. Electrical connection between the first identification member 4211 and different second identification members 4212 results in different resistance outputs from the identification board 421. It should be noted that the parameter of the different outputs may alternatively be measured as a current value or a voltage value.

In one embodiment, the number of the second identification members 4212 is seven, such that these second identification members 4212 together with the first identification member 4211 enable the identification board 421 to generate seven different outputs. In one embodiment, based on these seven different outputs, the control board 5 can control the actuating assembly 3 to output seven different torque levels. That is, the electric tool 100 has seven torque settings, each torque setting corresponding to a specific torque value or torque range. In this way, the electric tool 100 can meet the requirements for different torque levels according to varying load conditions.

It is understood that the detection assembly 42 is not limited to the foregoing configuration and can employ other rotational detection means as required. For example, in another embodiment, the detection assembly 42 may include Hall sensors and multiple magnets. When the pushing member 413 drives different magnets to move relative to the Hall sensors on the identification board 421, the Hall sensors generate different outputs depending on the magnets. Based on the different outputs of the Hall sensors on the identification board 421, the control board 5 can control the actuating assembly 3 to output torque within different ranges. In another embodiment, the detection assembly 42 may include a rotary encoder. Specifically, the pushing member 413 drives a code disc to rotate, and an optoelectronic or magnetoelectric sensor detects changes in the light/dark pattern of the markings. Each time a change occurs, the sensor outputs a pulse signal, and different numbers of pulses correspond to different rotation angles (i.e., angular displacements). That is, the detection assembly 42 can generate an output based on the relative displacement of the moving member 411 that moves synchronously with the pushing member 413 (specifically, the relative angular displacement of the moving member 411 with respect to the connecting member 412).

In one embodiment, referring to FIG. 11, the adjustment member 422 includes a third elastic member 4221, a first electrical contact post 4222, and a second electrical contact post 4223. The third elastic member 4221 abuts against the pushing member 413. One end of the third elastic member 4221 abuts against the first electrical contact post 4222, such that the first electrical contact post 4222 is urged into contact with the first annular identification member 4211. The other end of the third elastic member 4221 abuts against the second electrical contact post 4223, such that the second electrical contact post 4223 can abut against one of the second identification members 4212. In one embodiment, the third elastic member 4221 is a spring.

In one embodiment, referring to FIG. 9, the pushing member 413 is provided with a first receiving groove 4132. One end of the third elastic member 4221, one end of the first electrical contact post 4222, and one end of the second electrical contact post 4223 are all received in the first receiving groove 4132. The first electrical contact post 4222 and the second electrical contact post 4223 are both movable along the first receiving groove 4132.

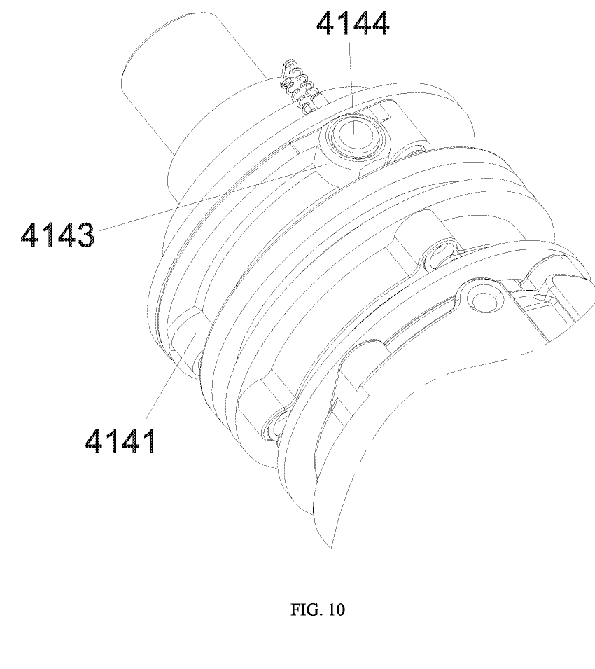

Referring to FIGS. 9 and 10, in one embodiment, in order to provide feedback to a user when the user rotates the pushing member 413 to adjust torque, the electric tool 100 further includes a base portion 4143 and a positioning member 4144 that are disposed on a circumferential side surface of the support ring 4141. The base portion 4143 is provided with a receiving cavity, and the positioning member 4144 is received in the receiving cavity of the base portion 4143. A compression spring is disposed between the positioning member 4144 and a bottom of the receiving cavity. A number of grooves 4131 extending along a lengthwise direction of the pushing member 413 are formed on a circumferential inner side surface of the pushing member 413. An end of the positioning member 4144 is received in one of the grooves 4131. The number of the grooves 4131 is the same as the number of the second identification members 4212. When the first identification member 4211 contacts a different second identification member 4212, the end of the positioning member 4144 is received in a different groove 4131. Accordingly, when the user rotates the pushing member 413, a clicking sound generated when the positioning member 4144 moves into a groove 4131 enables the user to determine that the pushing member 413 has been rotated to a position corresponding to a new torque setting.

In one embodiment, referring to FIGS. 5 and 6, in order to limit the mounting member 2 and secure the identification plate 421 and the support ring 4141, the adjustment mechanism 4 further includes a pressing member 44. The pressing member 44 is arranged around the mounting member 2, and the pressing member 44 is connected to the other end of the fixing member 43 by a screw, such that the pressing member 44 and the other end of the fixing member 43 clamp the identification plate 421 and the support ring 4141.

In one embodiment, referring to FIGS. 1 and 2, the electric tool 100 further includes a display 6 disposed on the housing 11 and is electrically connected to the control board 5 (specifically, electrically connected to the control module 10). The display 6 is to display information. While the control module 10 performs corresponding operations based on the output from the detection assembly 42, the control module 10 controls the display 6 to display corresponding prompt information, such as a torque setting. For example, when the user pushes the pushing member 413 to drive the moving member 411 to adjust the output torque of the electric tool 100, the display 6 can display the current torque setting. In this way, in addition to determining that the pushing member 413 has been rotated to a position corresponding to a new torque setting through the clicking sound generated when the positioning member 4144 moves into a groove 4131, the user can also visually confirm, via the prompt information displayed on the display 6, whether the pushing member 413 has been rotated to the position corresponding to a desired torque setting.

In one embodiment, referring to FIGS. 1 and 2, the electric tool 100 further includes a switch assembly 7. The switch assembly 7 includes a trigger 71 and a travel switch 72. The trigger 71 is disposed on the housing 11, and the travel switch 72 is disposed in the receiving chamber 111. The travel switch 72 is connected to the trigger 71 and is electrically connected to the control board 5. When the user presses the trigger 71, the trigger 71 drives the travel switch 72 to move, such that the control board 5 controls the actuating member 32 to operate.

In one embodiment, referring to FIG. 2, the electric tool 100 includes a power source 8. The power source 8 is disposed in the receiving chamber 111 and is electrically connected to the control board 5. The power source 8 is to supply electrical power.

In one embodiment, referring to FIGS. 1 and 2, the electric tool 100 further includes a direction switch 9. The direction switch 9 is disposed on the housing 11 and is electrically connected to the control board 5. The direction switch 9 is to switch a rotational direction of the actuating member 32 between forward rotation and reverse rotation.

In summary, the electric tool 100 includes a housing 1, a mounting member 2, an actuating mechanism 3, an adjustment mechanism 4, and a control board 5. The mounting member 2 is configured for insertion and mounting of a tool bit. The actuating mechanism 3 is disposed in the housing 1 and is connected to the mounting member 2. The adjustment mechanism 4 includes an adjustment assembly 41 and a detection assembly 42. The adjustment assembly 41 includes a moving member 411, a connecting member 412, and a pushing member 413. The moving member 411, the connecting member 412, the pushing member 413, and the detection assembly 42 are all disposed in the housing 1. The moving member 411 and the pushing member 413 are movable relative to the mounting member 2. The moving member 411 abuts against the connecting member 412, and the pushing member 413 is connected to the moving member 411. The pushing member 413 is to drive the moving member 411 to move. The control board 5 is electrically connected to the actuating mechanism 3 and the detection assembly 42, and the control board 5 controls the actuating mechanism 3 according to an output of the detection assembly 42. By virtue of the moving member 411 abutting against the connecting member 412, an initial movement of the moving member 411 driven by the pushing member 413 is resisted, thereby reducing a movement speed of the moving member 411 during an initial adjustment stage. As a result, excessive movement of the moving member 411 is avoided, and torque adjustment accuracy in the initial stage is improved.

The electric tool 100 may be an electric screwdriver, a power drill, or an electric rotary tool. However, a person skilled in the art, upon understanding the spirit of the present disclosure, will appreciate that the configuration of the electric tool 100 described above is also applicable to other electric tools that require precise output adjustment.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. An electric tool comprising:
a housing;
a mounting member configured to connect with a tool bit;
an actuating mechanism arranged within the housing and connected to the mounting member;
an adjustment mechanism comprising an adjustment assembly and a detection assembly, the adjustment assembly comprising a moving member, a connecting member, and a pushing member, the moving member, the connecting member, the pushing member, and the detection assembly being all arranged within the housing, the moving member and the pushing member being movable relative to the mounting member, the moving member abutting against the connecting member, the pushing member being connected to the moving member, wherein the pushing member is configured to drive the moving member to move, and the detection assembly is configured to generate a corresponding output based on a relative position or relative displacement of the moving member; and
a control module electrically connected to the actuating mechanism and the detection assembly, wherein the control module is configured to control the actuating mechanism according to the output from the detection assembly.

2. The electric tool of claim 1, wherein a protrusion is provided on one side of the moving member; the connecting member defines a groove and comprises a guide inclined surface, the groove is configured to receive the protrusion, the guide inclined surface comprises two ends respectively connected to a first side surface of the groove and to a surface of the connecting member facing the moving member; and when the moving member moves in a first direction, the guide inclined surface is configured to guide the protrusion to move out of the groove.

3. The electric tool of claim 2, wherein the adjustment assembly further comprises a support assembly, the support assembly comprise a support ring and a first elastic member, the support ring is arranged in the housing and is configured to support the detection assembly, and the first elastic member abuts against the support ring and the moving member.

4. The electric tool of claim 3, wherein the adjustment mechanism further comprises a fixing member arranged around the actuating mechanism and the mounting member, wherein the support ring, the moving member, the connecting member, and the pushing member are all arranged around the fixing member.

5. The electric tool of claim 4, wherein the actuating mechanism comprises a transmission assembly and an actuating member connected to the transmission assembly, the transmission assembly is connected to the mounting member, and the fixing member is arranged around the transmission assembly; and the adjustment assembly further comprises a second elastic member and a first abutting member, the second elastic member comprises two ends that respectively abut against the first abutting member and the connecting member, the first abutting member is arranged on the fixing member, the connecting member is movable relative to the fixing member, and the first abutting member abuts against the transmission assembly.

6. The electric tool of claim 1, wherein the detection assembly comprises an identification plate and an adjustment member, the identification plate is arranged around the mounting member and electrically connected to the control module, the adjustment member is connected to the pushing member and abuts against the identification plate; and the identification plate comprises a first annular identification member and a plurality of second identification members, the plurality of second identification members are circumferentially arranged at intervals around the identification plate, the adjustment member comprises two ends that respectively abut against the first annular identification member, and one of the second identification members, so as to electrically connect the first annular identification member to the one of the second identification members.

7. An electric tool comprising:
a housing;
an adjustment assembly comprising a pushing member and a resistance mechanism, the pushing member being movably connected to the housing, and the resistance mechanism being configured to provide damping when the pushing member is operated by a user;
a detection assembly configured to generate a corresponding output in response to movement of the pushing member relative to the housing; and
a control module electrically connected to the detection assembly, wherein the control module performs corresponding operations according to the output from the detection assembly.

8. The electric tool of claim 7, wherein the adjustment assembly further comprises a moving member and a connecting member, the moving member is movably arranged within the housing and connected to the pushing member so as to be movable together with the pushing member, and the connecting member is arranged within the housing;
wherein the resistance mechanism is arranged between the connecting member and the moving member, or is arranged between the pushing member and the detection assembly, or is arranged between the pushing member and the housing.

9. The electric tool of claim 8, wherein the resistance mechanism comprises a protrusion provided on the moving member, and a groove and a guide inclined surface provided on the connecting member; the groove is configured to receive the protrusion, the guide inclined surface extends from a first side surface of the groove to a surface of the connecting member facing the moving member, and when the moving member moves in a first direction, the guide inclined surface is configured to guide the protrusion to move out of the groove.

10. The electric tool of claim 9, wherein the adjustment assembly further comprises a support assembly, the support assembly comprise a support ring and a first elastic member, the support ring is arranged in the housing and is configured to support the detection assembly, and the first elastic member abuts against the support ring and the moving member.

11. The electric tool of claim 10, wherein the adjustment mechanism comprises a fixing member arranged around the actuating mechanism, and the support ring, the moving member, the connecting member, and the pushing member are all arranged around the fixing member.

12. The electric tool of claim 11, wherein the pushing member is rotatably connected to the housing, and the connecting member is threadedly connected to the fixing member.

13. The electric tool of claim 12, wherein the adjustment assembly further comprises a second elastic member located on a side of the connecting member opposite to the moving member, and the second elastic member applies a pushing force to the connecting member.

14. The electric tool of claim 13, further comprising an actuating mechanism arranged in the housing, wherein the actuating mechanism comprises a transmission assembly and an actuating member, the actuating member is connected to the transmission assembly, the transmission assembly comprises a transmission sleeve with an internal gear; the adjustment assembly further comprises a first abutting member, the first abutting member is pushed by the second elastic member to abut tightly against one end of the transmission sleeve, such that the transmission sleeve remains stationary when a load torque applied to the actuating member does not exceed a preset value.

15. The electric tool of claim 7, wherein the detection assembly comprises an identification plate arranged within the pushing member and an adjustment member, the identification plate is electrically connected to the control module, the adjustment member is connected to the pushing member and abutting against the identification plate, and, driven by the pushing member, the adjustment member is movable relative to the identification plate; the adjustment member and the identification plate are configured such that movement of the adjustment member relative to the identification plate causes a change in a resistance output by the identification plate.

16. The electric tool of claim 15, wherein the identification plate comprises a first identification member and a plurality of second identification members, the plurality of second identification members are spaced apart from one another and spaced apart from the first identification member, the adjustment member comprises two ends abutting against the identification plate, and, when the adjustment member moves together with the pushing member, one end of the adjustment member remains in contact with the first identification piece, and the other end of the adjustment member is configured to sequentially contact the second identification members located at different positions, such that the first identification member is electrically connected to respective ones of the plurality of second identification members located at different positions, thereby causing movement of the adjustment member relative to the identification plate to result in a change in a resistance output by the identification plate.

17. The electric tool of claim 16, wherein each of the second identification members is a fixed-value resistor or a variable-value resistor.

18. The electric tool of claim 7, wherein the resistance mechanism is configured to provide damping when the pushing member starts to move from an initial position relative to the housing.

19. The electric tool of claim 7, wherein the pushing member is arranged at a front portion of the housing.

20. The electric tool of claim 7 further comprising a display electrically connected to the control module, wherein, while performing corresponding operations according to the output from the detection assembly, the control module controls the display to display corresponding prompt information.
